(19) United States
(12) Patent Application Publication
(10) Pub. No.: US 2004/0200439 A1
(43) Pub. Date: Oct. 14, 2004

(54) Method and apparatus for repelling animals from electric power distribution equipment

(76) Inventors: James F. Thomas, Ft. Lauderdale, FL (US); Robert L. Nichols, Ft. Lauderdale, FL (US)

Correspondence Address: Mark D. Bowen, Stearns Weaver Miller, et al., Suite 1900, 200 East Broward Boulevard, Fort Lauderdale, FL, 33301, US

(21) Appl. No.: 10/809,734

(22) Filed: Mar. 25, 2004

Related U.S. Application Data
(60) Provisional application No. 60/457,498, filed on Mar. 25, 2003.

(51) Int. Cl. A01K 61/02

(52) U.S. Cl. 119/903

(57) ABSTRACT

An apparatus and method for repelling animals, such as rodents and birds, from electrical power distribution equipment using voltages induced from inductive coupling with electromagnetic fields generated by said equipment is disclosed. Animals are repelled by non-lethal electrical shocks administered when the animal comes in contact with the system. An electrical potential above ground potential is induced and maintained on the system without the requirement of a direct electrical connection to an electric power source. The induced electrical potential discharges upon contact with an animal thereby producing a non-lethal electric shock that effectively discourages the animal from remaining in the area.

### CROSS REFERENCE TO RELATED APPLICATIONS

This application claims the benefit of provisional U.S. Patent Application Serial No. 60/457,498, filed Mar. 25, 2003

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights.

### BACKGROUND OF THE INVENTION

1. Field of the Invention

The present invention relates generally to systems for repelling animals, such as birds, rodents, and amphibians. More particularly, the present invention relates to devices for repelling such creatures by electric shock.

2. Description of the Background Art

The use of non-lethal electrical shock to repel animals and creatures of all types is known to be highly effective. Thus, the use of electrical shock devices to repel animals from selected areas is known. The ability to successfully repel animals, such as rodents and birds, from man made structures is important in maintaining the aesthetics of the structures, as well as the health and safety of the occupants of the structures. For example, it is known in the art to use systems capable of producing mild electrical shocks to deter birds from roosting on buildings, and thus to prevent the accumulation of unsightly bird droppings. One environment wherein it is particularly important to prevent animals from inhabiting is electric power generation and distribution facilities. In such environments birds, such as Quaker and Monk parrots, are known to build nests in electrical power distribution equipment. The nests result in the accumulation of debris in and around the electrical power distribution equipment thereby resulting in a fire hazard.

As a result of the problems associated with animals inhabiting various man made structures, the prior art reveals a number of systems that utilize a direct connection to an external power source to repel animals by selectively administering electrical shocks. For example, U.S. Pat. No. 2,400,829, issued to Kennedy, discloses an electric fence designed to prevent the entrance of rodents and the like within a predetermined area using power provided by a conventional electric transformer. The electric fence can be regulated so as to either produce a lethal shock capable of killing the rodents, or to merely produce a non-lethal shock. U.S. Pat. No. 3,366,854, issued to Robinson, discloses an apparatus for electrically repelling pests, such as birds from building ledges, roofs, and other perching locations. The apparatus includes a pair of electrical conductors formed within a cable wherein surface portions of both conductors are exposed. The exposed portions are positioned slightly above a roosting surface, and, given that birds prefer to perch on the elevated cable rather than the lower surface, the cable provides a roosting ridge. With the conductors on horizontally opposite sides of the cable, opposed digits of at least one of the birds feet will be in direct contact with the two conductors, each of which is at a different voltage. Thus, current flows though the bird's foot causing a shock.

U.S. Pat. No. 3,504,892, issued to Crest, discloses a self-contained electric fence cable including a pair of insulated wire conductors having a plurality of flat conductor plates mounted thereon, with alternate plates having electrical contact with the same conductor such that the cable assembly will produce a local shock when adjacent plates are contacted by an animal.

U.S. Pat. No. 3,878,444, issued to Miller, discloses an apparatus for protecting electrical cables against rodent damage. Miller provides a plurality of electrical conductors and a cylindrical jacket surrounding and binding the conductors, a wire wrapping surrounds the jacket, and the wrapping includes an outer covering. The wrapping is connected to a selected area above ground so that when a rodent or larger animal bites the cable, the voltage on the wrapping will be impressed on the animal to ground. This provides a mild shock to the animal so as to deter it from again biting the cable.

U.S. Pat. No. 4,015,176, issued to Shanahan, discloses an apparatus for removing birds and other pests. The apparatus includes an elongated base which carries two uninsulated electric wires connected to a power source for providing a voltage difference between the wires. The base may be an electric cable to be protected from rodents.

U.S. Pat. No. 4,862,637, issued to Dressel, discloses a bird repelling device adapted for use in a vineyard wherein conductive trellis wires extend between poles. A number of such devices are widely spaced throughout the vineyard. Each has a length much shorter than the distance between adjacent vineyard poles, the length being sufficient to allow a bird to land, having a circumference less than approximately one and one-half inch to allow the feet of a bird landing to cover most of its circumference. Each is composed of an elongate insulating member and an electrically conductive rod secured to it. A high voltage is applied to each electrically conductive rod. A bird landing on the device completes a circuit between the trellis wire and the electrically conductive rod carried by the device that shocks the bird without substantially harming it so that the bird flies away.

U.S. Pat. No. 5,850,808, issued to Burdick, discloses an elongated A-shaped plastic support having three spaced apart conductors running along the length of the support, with the middle conductor elevated relative to the other conductors and connected to a different potential of a power supply than the other conductors such that when a pigeon or other pest steps on adjacent conductors, a circuit is completed to electrically shock the pest.

While the prior art repelling systems appear adequate in certain environments, they share common disadvantages. First and foremost among the disadvantages present in the art is the requirement for an external electrical power source. The systems of the background art each require direct electrical connection to an external electrical power supply, thereby complicating installation and resulting in a potentially hazardous environment. Accordingly, there exists a need for an apparatus and method for repelling animals by electric shock, without requiring direct electrical connection to an electrical power source.

### BRIEF SUMMARY OF THE INVENTION

The present invention overcomes the shortcomings and disadvantages present in the art by providing an apparatus and method for repelling animals, such as rodents and birds, from certain areas using voltages induced from inductive coupling with electromagnetic fields generated by nearby electrical power transmission and distribution equipment. The present invention provides a system capable of administering a non-lethal electrical shock to an animal coming in contact with the system, without the requirement for a direct electrical connection to an external power source. In a preferred embodiment, a system according to the present invention includes at least one electrical conductor attached in proximity to electrical power transmission and/or distribution equipment, such as a transformer, and supported in spaced relation thereto by electrically insulated support brackets. A significant aspect of the present invention involves the use of inductive coupling to induce an electrical potential on a conductor from an electromagnetic fields emanating from a transformer. The induced electrical potential discharges upon contact with an animal thereby producing a non-lethal electric shock that effectively discourages the animal from remaining in the area. A sufficient number of conductors may be disposed at any given area to effectively render the equipment off-limits to birds, rodents, and other animals. The system may further incorporate a variable resistor and grounded connection for regulating the induced electrical potential on the conductor within a predetermined and selected range, such as below a lethal voltage.

Accordingly, it is an object of the present invention to provide an improved system and method for deterring animals from nesting or scavenging on electrical power transmission and distribution equipment.

Another object of the present invention is to provide a system capable of generating an electrical shock without requiring direct connection to an external power source.

Still another object of the present invention is to provide a system and method for discouraging animals from entering selected areas using electrical potential induced from electromagnetic fields.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a perspective view of an animal repelling apparatus according to the present invention;

FIG. 2 is a sectional view thereof;

FIG. 3 is a side view thereof;

FIG. 4 depicts an alternate embodiment incorporating voltage regulating capabilities;

FIG. 5 is an electrical schematic of an embodiment adapted for regulating the electrical potential of the system; and

FIG. 6 illustrates an apparatus according to the present invention in relation to an electrical power distribution structure generating an electromagnetic field.

### DETAILED DESCRIPTION OF THE INVENTION

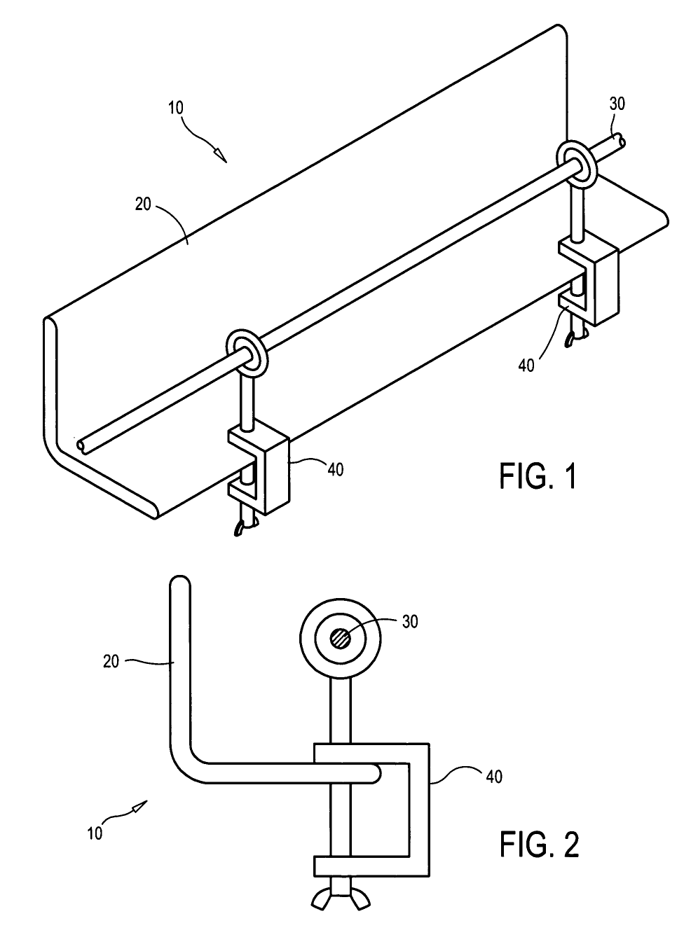

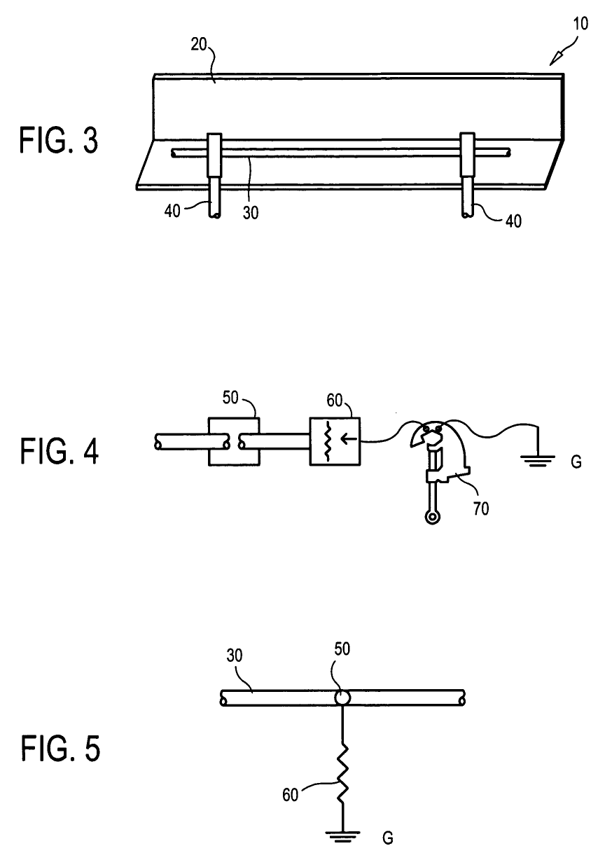

With reference to the drawings, FIGS. 1-6 depict a preferred embodiment of an animal repelling system according to the present invention, generally referenced as 10, operationally installed in proximity to electrical transmission and distribution equipment referenced as 12. The system functions to repel animal pests, such as birds, rodents, and snakes, by electrical shock upon contact. More particularly, the present invention provides a system capable of administering a non-lethal electrical shock to an animal coming in contact with the system, without the requirement for a direct electrical connection to an external power source.

FIGS. 1-3 depict a preferred embodiment of the present invention. A system according to the present invention includes an elongate rigid member 20, which is a mounting platform for attachment of the invention to a structure, preferably an angled steel bracket commonly referred to as angle iron. In addition, at least one electrical conductor 30 is supported in spaced relation to rigid member 20 by electrically insulated support brackets 40. In an alternate embodiment, conductor 30 may be supported by a conventional metal bracket adapted with an electrically insulating busing, referenced as 42. Rigid member 20 may be of any length or shape suitable for functioning as a support base for the system. Rigid member 20 is fabricated from conductive material, such as steel or iron, and is electrically grounded when installed on a given piece of electrical power distribution equipment, such as a transformer or substation structure. Conductor 30 is preferably a bare (i.e. no insulation coating) copper wire of a suitable gage, such as 16 gage copper conductor. Support brackets 40 are clamps that are preferably fabricated from electrically insulated material, such as dielectric clamps, and function to maintain conductor 30 in spaced relation with the grounded rigid member as best depicted in FIG. 2.

The system 10 is installed by direct attachment to an active electric transmission or distribution component, such as a transformer or substation apparatus, referenced as 12. It is well known that electricity flowing through such equipment generates an electromagnetic field in the area surrounding the equipment. The present invention functions by inductive coupling in conjunction with the electromagnetic field to induce a voltage potential on conductor 30. More particularly, attaching a system according to the present invention to a substation component places conductor 30 within the electromagnetic field emanating therefrom. Exposure to the electromagnetic field induces a voltage potential on the insulated conductor 30, without requiring a direct electrical connection to an external power source. The induced electrical potential will dissipate upon contact with an animal standing on or in contact with a grounded structure, such as rigid member 20 or part of the grounded electrical distribution equipment, such that the creature's body completes an electrical circuit between charged conductor 30 and ground producing a non-lethal electric shock that effectively discourages the animal from remaining in the area. A sufficient number of conductors may be disposed at any given area to effectively render the equipment off-limits to birds, rodents, and other animals.

In an alternate embodiment depicted in FIGS. 4 and 5, the induced electrical potential is regulated by use of a voltage regulating system. In this embodiment, a variable resistor 60 is electrically connected to conductor 30 via a splice connection 50. Variable resistor 60 is connected to ground “G” via a suitable ground connection 70. Variable resistor 60 thus functions to maintain the induced electrical potential below a predetermined level thereby preventing the system from accumulating a lethal charge.

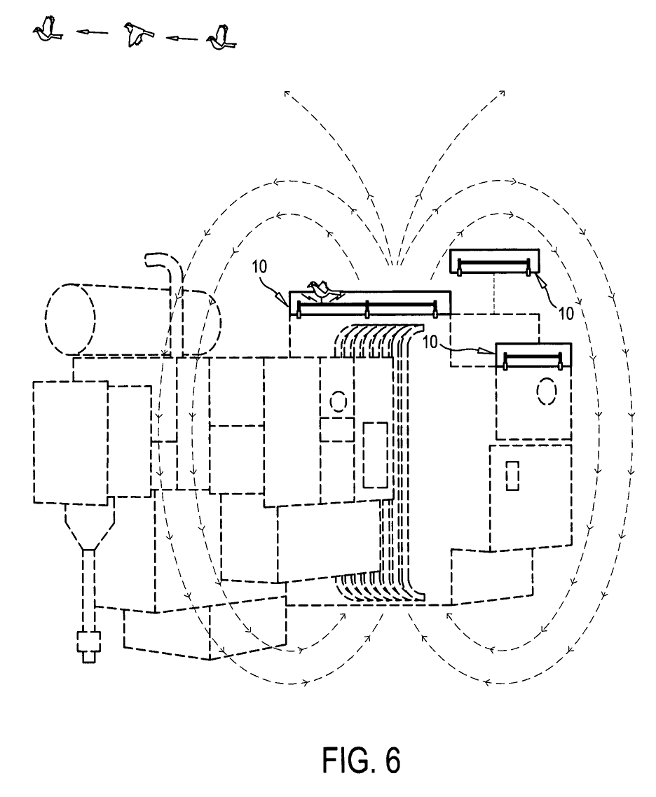

FIG. 6 depicts the system of the present invention, referenced as 10, in relation to an electric power distribution structure 80. As illustrated in FIG. 6, electric power distribution structure 80 generates an electromagnetic field represented by the field lines shown in phantom. One or more systems 10 according to the present invention are installed on structure and within the electromagnetic field, preferably at locations on said structure wherein it is desirable to prevent animals from inhabiting. The electromagnetic field induces an electrical potential above ground potential on the electrical conductor via inductive coupling. As should be apparent, there is no direct electrical connection between the electrical conductor and an electrical power source. Once the electrical potential is induced on the conductor, an electrical charge or shock is automatically administered to any creature that contacts the conductor while also contacting any part of the grounded structure or apparatus.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. An apparatus for repelling creatures, such as rodents and birds, from electrical power distribution equipment, said electrical power distribution equipment generating an electromagnetic field, said apparatus comprising:
a bare electrical conductor mounted on said electrical power distribution equipment within said electromagnetic field and in electrically insulated spaced proximity to an electrically grounded conducting structure;
said electrical conductor acquiring an electrical potential induced thereon by said electromagnetic field;
whereby a creature coming into contact with both said electrical conductor and said grounded conducting structure completes an electrical circuit and is administered an electrical shock.

2. An apparatus according to claim 1, wherein said electrically grounded conducting structure comprises angle iron.

3. An apparatus according to claim 1, wherein said bare electrical conductor comprises copper wire.

4. An apparatus according to claim 1, further including voltage regulation means for regulating the voltage induced on said bare electrical conductor.

5. An apparatus according to claim 4, wherein said voltage regulation means comprises a variable resistor electrically connected to said bare electrical conductor and to a grounded structure.

6. An installation for repelling animals, such as birds and rodents, from electrical power distribution equipment, said electrical power distribution equipment generating an electromagnetic field, said installation comprising:
an electromagnetic field;
an electrically grounded structure disposed within said electromagnetic field;
electrically insulated means for supporting a bare electrical conductor in a substantially horizontal plane in proximally spaced relation with said electrically grounded structure, such that an electric potential in induced on said bare electrical conductor by said electromagnetic field; and
whereby a creature coming into contact with both said electrical conductor and said grounded conducting structure completes an electrical circuit and is administered an electrical shock.

7. An installation for repelling animals according to claim 6, further including voltage regulation means for regulating the voltage induced on said bare electrical conductor.

8. An installation for repelling animals according to claim 7, wherein said voltage regulation means includes a manually variable resistor.
